(19) United States
(12) Patent Application Publication
(10) Pub. No.: US 2003/0196328 A1
(43) Pub. Date: Oct. 23, 2003

(54) Gel blades

(76) Inventors: Antonio Andino, Middletown, CT (US); Donna Marie O'Brien, East Hartford, CT (US)

Correspondence Address: Antonio Andino Vazquez, 4233 Town Place, Middletown, CT, 06457, US

(21) Appl. No.: 10/127,258

(22) Filed: Apr. 22, 2002

(51) Int. Cl. B26B 19/44

(52) U.S. Cl. 30/41; 30/125; 30/535

(57) ABSTRACT

This invention would make shaving for the traveler more convenient. You would only have to have one razor and would not have to carry a cumbersome can of shaving cream or gel. It could be used by hotels and hospitals, and sold in airports, train and bus stations, and any convenience stores.

Start with any disposable razor with a hollow handle. Cut out a ⅛th inch strip from the left and right sides of the handle, starting from just below the neck and continuing to just above the bottom of the handle. Insert a small bag or tube filled with shaving gel into the hollow of the handle, attaching the top of it to the neck of the razor. The bottom of the tube of shaving gel would be attached to the bottom of the razor and would be threaded so a screw cap could be added to the bottom of the handle, holding the gel inside the razor. A free floating peg would be inserted at the top of the handle, into one of the ⅛th inch cut outs, over the tube of gel, and through the other ⅛th cut. Small grippers would be attached to each of the peg ends, but the peg would remain free the be able to be pushed down along the ⅛th inch cut outs.

When the person was ready to shave, they would remove the screw cap from the bottom of the razor, grab the grippers at the neck of the razor, pull the grippers down so that the peg inside the handle would move down along the cut out side strips and force the gel out through the bottom of the handle and onto their hand. The screw cap could then be put back on the end of the handle and any gel remaining inside would stay fresh for a possible second use of the razor.

### DESCRIPTION OF THE DRAWINGS

FIG. 1

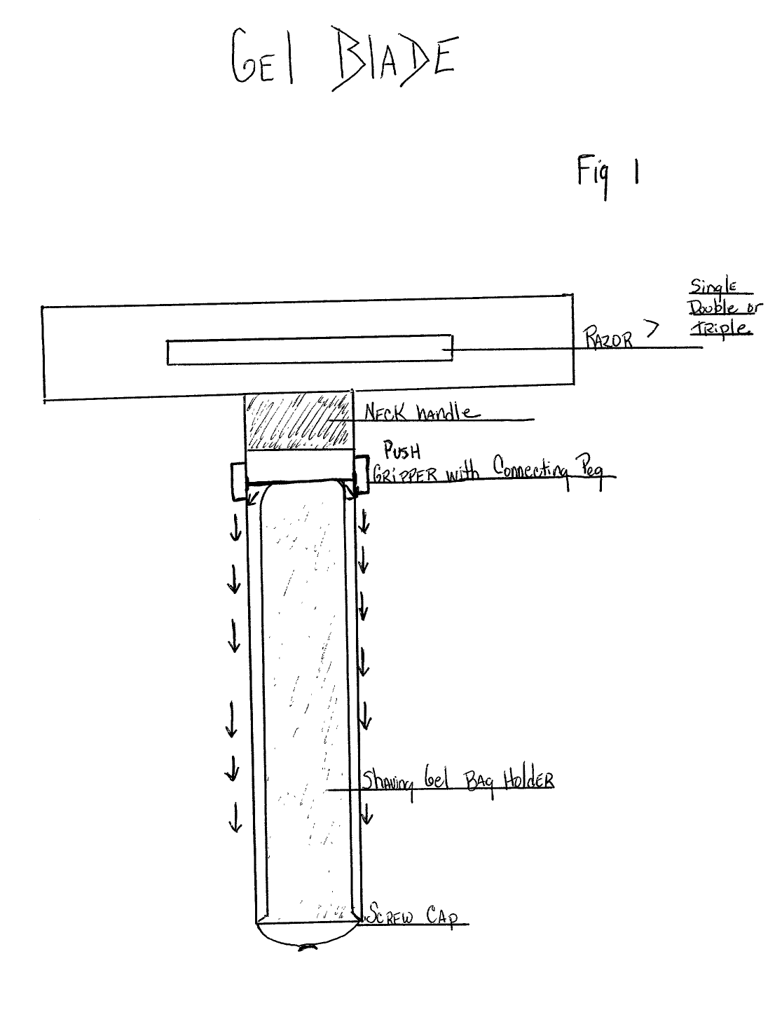

Front view shows razor and how the grippers would be used to move the gel down and out of the razor handle.

FIG. 2

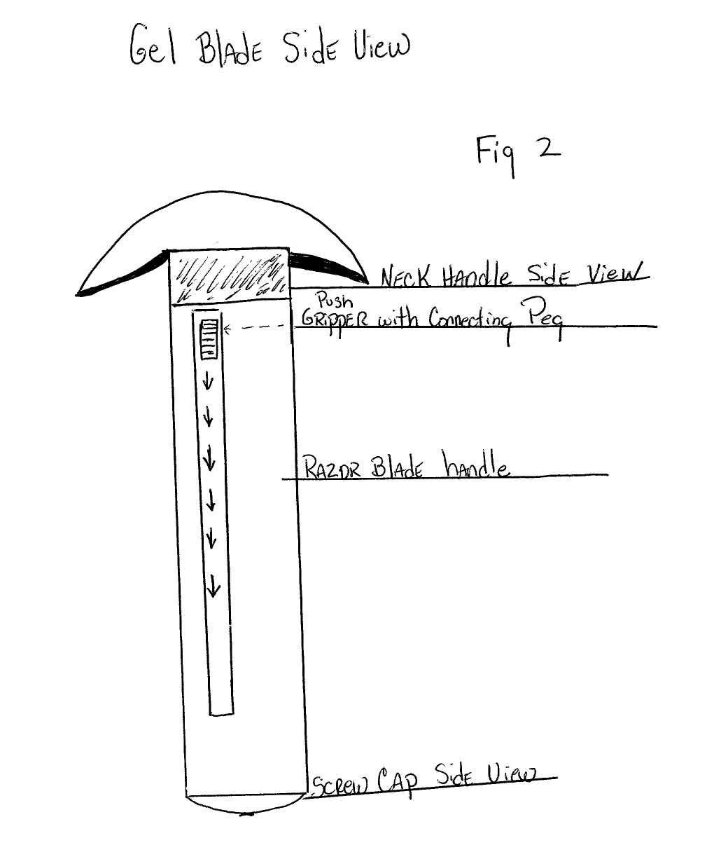

Side view shows how grippers would move down through the cut outs in the side of the razor handle.

1. What we claim as our invention is to improve upon the disposable razor by adding shaving gel and a dispense mechanism to the hollow handle of the razor, thereby creating one disposable item instead of having a razor and shaving gel as two separate items.
